(19) United States
(12) Patent Application Publication
(10) Pub. No.: US 2025/0005701 A1
(43) Pub. Date: Jan. 2, 2025

(54) EVALUATION METHOD, SEARCH METHOD, AND SEARCH SYSTEM

(71) Applicant: HITACHI HIGH-TECH CORPORATION, Tokyo (JP)

(72) Inventors: Isaac O'Bryant, Hillsboro, OR (US); Kohei Matsuda, Tokyo (JP); Takashi Dobashi, Hillsboro, OR (US); Jake D. O'Gorman, Hillsboro, OR (US); Stephen Black, Hillsboro, OR (US)

(21) Appl. No.: 18/215,350

(22) Filed: Jun. 28, 2023

(51) Int. Cl. G06F 16/532; G06F 16/583; G06T 7/60

(52) U.S. Cl. CPC G06T 1/20; G01N 21/00; G06T 7/60; G06T 2207/10056

(57) ABSTRACT

To provide a technique for evaluating a shape that appears in a cross-sectional image, one of the typical evaluation methods of the present invention evaluates a difference between a target shape and a cross-sectional shape of an electron microscopic image, and includes: a first step of measuring a characteristic dimension of the cross-sectional shape; after the first step, a second step of creating a template of the target shape in the cross-sectional shape obtained from the dimension; and a third step of comparing a difference between the template and the cross-sectional shape using a normalized metric.

### TECHNICAL FIELD

The present invention relates to an evaluation method, a search method, and a search system.

### BACKGROUND ART

In general, manufacturing data is very important and valuable in a manufacturing system. With the progress in data analysis tools and algorithms, it is critical for positive growth in a highly competitive business environment to constantly seek more sophisticated and simpler ways to reduce our workload.

As we collect more and more information, the amount of data can scale up rapidly. This requires more resources and time for analysis, which tends to slow down the process development.

Such is the case in the semiconductor industry. For example, intense analysis using microscopic images is required to evaluate the success of etching experiments.

Conventionally, methods for analyzing microscope images have been proposed. For instance, Patent Document 1 discloses a dimension measuring apparatus that reduces the time required for dimension measurement and eliminates operator-induced errors. The dimension measuring apparatus in Patent Document 1 obtains coordinates of a plurality of feature points defined in advance for each of the unit patterns using a first image recognition model and a second image recognition model, the first image recognition model extracting a boundary line between a processing structure and a background and/or a boundary line of an interface between different kinds of materials over the entire cross-sectional image, the second image recognition model outputting information for dividing the boundary line extending over the entire cross-sectional image obtained from the first image recognition model into unit patterns constituting a repetitive pattern, and thus measures a dimension defined as a distance between two predetermined points among the plurality of feature points.

### CITATION LIST

### Patent Document

Patent Document 1: WO 2020/121564

### SUMMARY OF THE INVENTION

### Problem to be Solved by the Invention

In Patent Document 1, a plurality of feature points are extracted from a microscope image for evaluating the dimension of the repeated pattern, but there is still room for improvement in the method of evaluating the shape of the pattern.

The present invention therefore aims to provide a technique for evaluating a shape that appears in a cross-sectional image.

### Means for Solving the Problems

To solve the above problems, one of the typical evaluation methods of the present invention evaluates a difference between a target shape and a cross-sectional shape of an electron microscopic image. The method includes: a first step of measuring a characteristic dimension of the cross-sectional shape; after the first step, a second step of creating a template of the target shape in the cross-sectional shape obtained from the dimension; and a third step of comparing a difference between the template and the cross-sectional shape using a normalized metric.

### Advantageous Effect of the Invention

The present invention enables evaluation of a shape that appears in a cross-sectional image.

Other problems, configurations and advantageous effects will be clear from the following descriptions of the embodiments.

### BRIEF DESCRIPTION OF THE DRAWINGS

FIG. 1 illustrates an example of a cross section of a semiconductor processing layer imaged by SEM.

FIG. 2 schematically illustrates an ideal rectangular profile.

FIG. 3 schematically illustrates a more realistic profile found in the etching process.

FIGS. 4A and 4B illustrate an example of applying the area method to the trench 4b illustrated in FIG. 3.

FIGS. 5A and 5B illustrate an example of applying the distance method to the trench 4b illustrated in FIG. 3.

FIG. 6 illustrates the process of data preparation.

FIGS. 7A and 7B illustrate an example of a profile diagram.

FIGS. 8A and 8B illustrate an example of the data obtained through the process of data preparation.

FIGS. 9A and 9B illustrate a case where the block region indicating the ideal shape is set so as to include the shoulder region located above the point having the x-coordinate value xₘₐₓ.

FIG. 10 illustrates the process of calculating the area number in Method 1.

FIGS. 11A and 11B illustrate a case where the block region 34, which represents the ideal shape, is set in the range of points with the value xₘₐₓ of the x coordinate.

FIG. 12 illustrates the process of calculating the area number in Method 2.

FIGS. 13A and 13B illustrate an example of scaling a profile diagram.

FIG. 14 illustrates the process of calculating the distance number in the distance method.

FIG. 15 illustrates an example of the configuration of an evaluation system with which the evaluation method described in this disclosure is performed.

FIGS. 16A and 16B illustrate the results of evaluating a semiconductor structure.

### MODES FOR CARRYING OUT THE INVENTION

The following describes one embodiment of the present invention, with reference to the attached drawings. The present invention is not limited to this embodiment. In the attached drawings, identical parts are shown with identical reference numerals.

When there are a plurality of components having the same or similar functions, they may be described with the same reference numeral and different suffixes. When there is no need to distinguish between these components, their suffixes may be omitted in the description.

In the drawings, the position, size, shape, range, and others of the components illustrated in the drawings may not be the actual position, size, shape, range, and others to facilitate understanding of the invention. The present invention therefore is not necessarily limited to the position, size, shape, range and others disclosed in the drawings.

In the present disclosure, coordinates may be described with suffixes indicating conditions. For instance, “x_{y=ymax}” means “the value of the x coordinate when the value of y is yₘₐₓ”.

A profile refers to an outline appearing in a cross section of a semiconductor. For instance, a “profile diagram” of a semiconductor structure means a view illustrating the outline defined by the boundary between the semiconductor structure portion and the space portion that appear when viewing a cross-section of the semiconductor substrate.

The width of a profile indicates the length in the direction parallel to the main surface of the semiconductor substrate. The height of the profile indicates the length in the direction perpendicular to the main surface of the semiconductor substrate.

### Problems of Conventional Technology

Although accurate evaluation is generally possible by collecting a large amount of data, there are problems when analyzing a large amount of data.

To offset an increase in data collection while maximizing the information on images with expensive scanning electron microscope (SEM), scanning transmission electron microscope (STEM) and transmission electron microscopy (TEM), it is often useful to represent the key structure with as few data points as possible and quickly analyze the results of a given experiment for reporting. However, some shapes or behaviors revealed in microscopic images of experimental semiconductor stacks are often difficult to quantify, despite their relevance.

Attempts to quantify these shapes are often done qualitatively using a single value by manual grading after SEM imaging or other inspections. This approach, however, leads to subjective measurements depending on who is grading the profile.

Because of this ambiguity, this approach is neither ideal nor accurate as a machine learning method.

For instance, it is useful to describe the squareness of a profile by using edge detection software and capturing the edge in the form of x and y coordinates. However, the more precise the shape is to be described, the more sample points are used, which makes it difficult to manually manage them, and brings a large collection of esoteric coordinates, which is not ideal for machine learning analysis. The user will suffer from these shortcomings.

The present disclosure therefore provides two methods for quantifying the overall shape of an ambiguous shape by comparing it to an ideal shape, using a single dimensionless quantity metric.

### EMBODIMENTS

### (Examples of Microscopic Images and Shapes to be Evaluated)

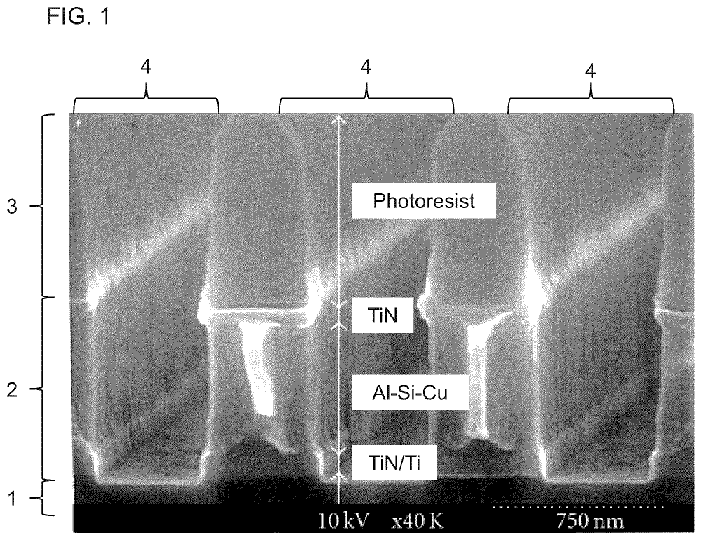

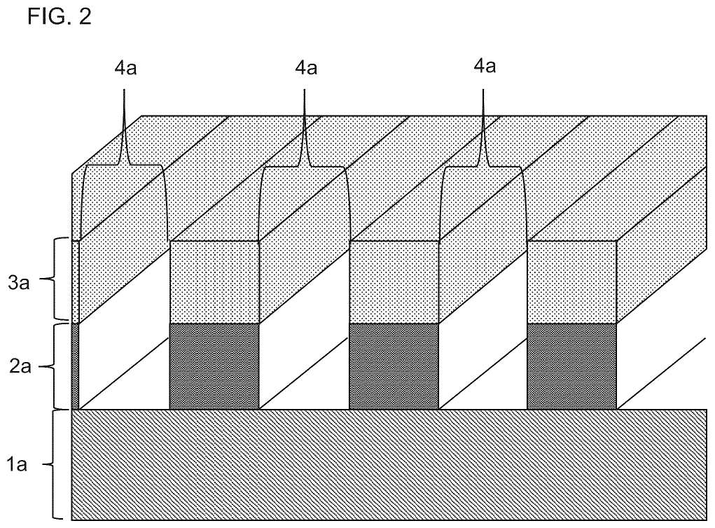

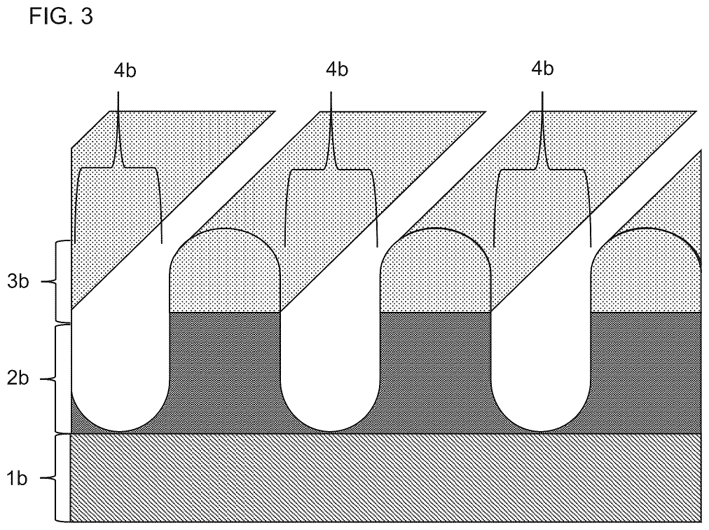

Referring to FIGS. 1 through 3, examples of microscopic images of a semiconductor processing substrate are shown. FIGS. 1 to 3 are perspective views including a part of the cross-section of a semiconductor processing substrate. FIG. 1 illustrates an example of a cross section of a semiconductor processing layer imaged by SEM. FIG. 2 schematically illustrates an ideal rectangular profile. FIG. 3 schematically illustrates a more realistic profile found in the etching process.

FIG. 1 shows an imaged cross-sectional view of a semiconductor processing substrate perpendicular to its main surface. It shows the state where, after forming a processing layer 2 including a TiN/Ti layer, an Al—Si—Cu layer, and a TiN layer, and a photoresist layer 3 having a predetermined pattern on a semiconductor substrate 1, etching is performed to form a trench 4 according to the predetermined pattern.

FIG. 2 illustrates a case where etching is performed ideally. Under ideal conditions, etching proceeds in a direction perpendicular to the main surface of the semiconductor substrate 1a and not in a direction parallel to the main surface of the semiconductor substrate 1a. The processing layer 2a and photoresist layer 3a have the same etching amount, so that the processing layer 2a and photoresist layer 3 have a uniform surface with respect to the trench 4a. As illustrated in FIG. 2, the ideal trench 4a has a rectangular shape extending perpendicular to the main surface of the semiconductor substrate 1a. In reality, however, it is difficult to realize the ideal shape because the etching amount differs depending on the composition contained in the photoresist layer 3a and the processing layer 2a.

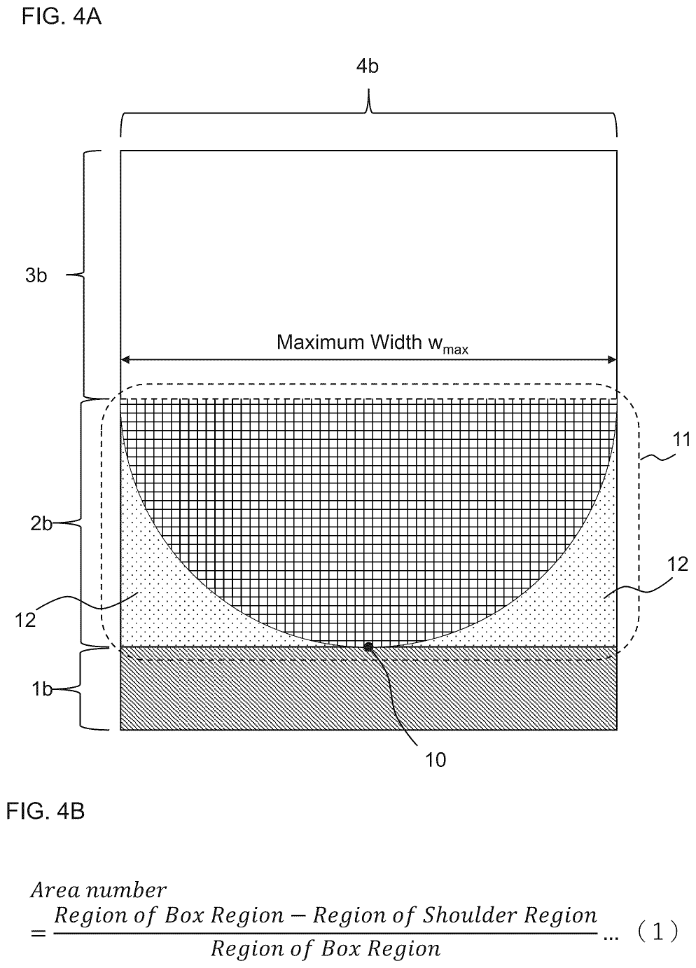

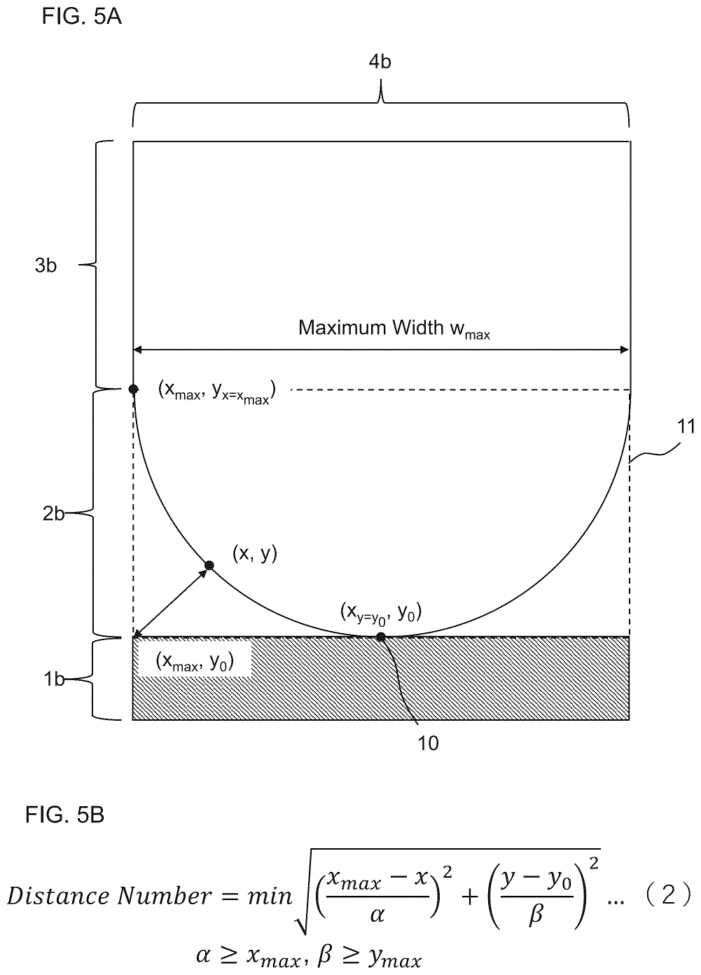

Referring to FIGS. 4A to 5B, two methods (area method and distance method) in the present disclosure are defined, which are for measuring how well a shape resembles a rectangle shape. The evaluation method in the present disclosure is to evaluate a difference between the target shape and the cross-sectional shape of an electron microscopic image. FIGS. 4A and 4B illustrates an example of applying the area method to the trench 4b illustrated in FIG. 3. FIGS. 5A and 5B illustrate an example of applying the distance method to the trench 4b illustrated in FIG. 3.

After numerically evaluating the shape using the edge detection software, a template of the ideal shape identified by the unique extrema is defined.

Scaling is then performed to allow different shapes to be meaningfully compared to each other.

In the area method, the region of the profile is subtracted from the ideal template, and the result is divided by the region of the ideal template to derive a measurement of dimensionless quantity.

More specifically, FIGS. 4A and 4B provide the overview of the area method. In FIG. 4A, a box region 11 (indicated by the dashed line) is defined, which is a rectangular region made up of a side of the same length as the maximum width wₘₐₓ of the trench 4b, which is the length parallel to the main surface of the semiconductor substrate 1b, a side including a point at the bottom 10 of the trench 4b, and a side of the trench 4b perpendicular to the main surface of semiconductor substrate 1b. A portion of the box region 11 excluding the portion of the trench 4b (the grid pattern portion in FIG. 4A) is referred to as a shoulder region 12. The area number, which is a metric calculated by the area method, is derived by equation (1), as indicated in FIG. 4B

$$\begin{matrix}[ Mathematical 1 ] & \\ Area number = \frac{Region of Box Region - Region of Shoulder Region}{Region of Box Region} & ( 1 )\end{matrix}$$

In the distance method, after scaling the data by local extrema, the point of the profile closest to a corner of the ideal template is evaluated to derive an evaluation of the dimensionless quantity.

More specifically, FIGS. 5A and 5B provide the overview of the distance method. In FIG. 5B, the box region 11 is set in the same manner as in FIG. 4A. Here, let the y-coordinate of the bottom 10 be y₀. Let xₘₐₓ be the value of the x-coordinate when it has the maximum width wₘₐₓ. A point (x, y) closest to a corner (xₘₐₓ, y₀) of the box region 11 is extracted from the shape of the trench 4b. The distance number, which is a metric derived by the distance method, is derived by equation (2), as indicated in FIG. 5B. In this equation, α and β are constants for normalization.

$$\begin{matrix}[ Mathematical 2 ] & \\ Distance number = min \sqrt{{( \frac{{x}_{max} - x}{α} )}^{2} + {( \frac{y - {y}_{0}}{β} )}^{2}} \\ α \geq {x}_{max} , β \geq {y}_{max} & ( 2 )\end{matrix}$$

These values are normalized with the unique extrema of each shape as described above, whereby a single dimensionless quantity value is obtained. The obtained value is used to compare the shape with a similar shape in another image and evaluate the squareness of the sample.

These normalized values can be used for better judgement of the success of an experiment and for simple quantification when information on an ambiguous but important shape is statistically analyzed.

### (Implementation Method)

We will now define two quantitative methods to describe a features conformity to an ideal shape by a single dimensionless quantitative metric.

These methods make use of edge detection software to quickly obtain a numerical description of the profile.

### (Data Preparation)

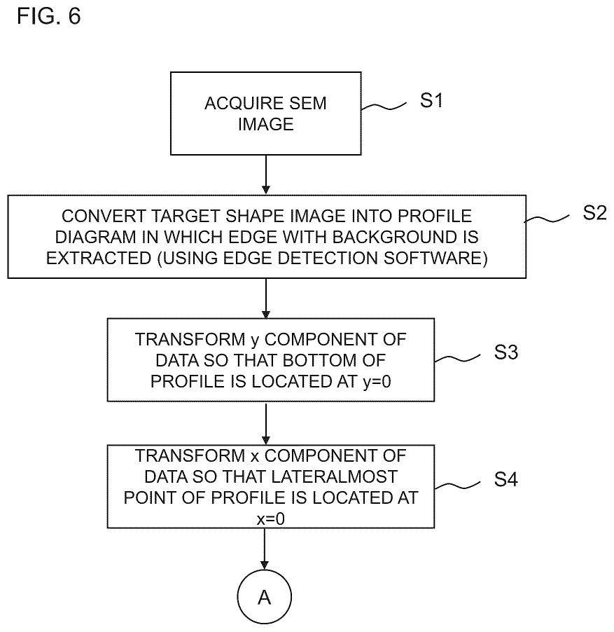

Referring to FIG. 6, the following describes the preparation of data used to calculate the metric. FIG. 6 illustrates the process of data preparation.

The process of data preparation is the first step in measuring characteristic dimension of the cross-sectional shape. First, the dimension of the shape are collected via the outline of the profile. This is best implemented using edge extraction software. In the following explanation, dimensions may also be referred to as CD values (critical dimension).

Specifically, first, a SEM image of a cross-section of the semiconductor processing substrate is acquired (step S1). Subsequently, the image of the target shape is converted into a profile diagram in which the edge with the background is extracted (step S2). Although it is an example by way of SEM, the present disclosure is not limited to this. It may be an image acquired by another microscope such as STEM or TEM.

Next, a change in profile width is considered as a function of profile height. The y component of the data is transformed so that the bottom of the profile is located at y=0. Specifically, the y component of the data is transformed so that the bottom of the profile is located at y=0 (step S3).

Next, the x component of the data is transformed so that the lateralmost point of the profile is located at x=0 (step S4). Specifically, the x component of the profile data is transformed using the maximum width value of the profile, so that one point of the width of the profile when it is widest is located at x=0 (step S4).

The above processing provides a set of unique extrema and parameters needed to calculate area and distance numbers.

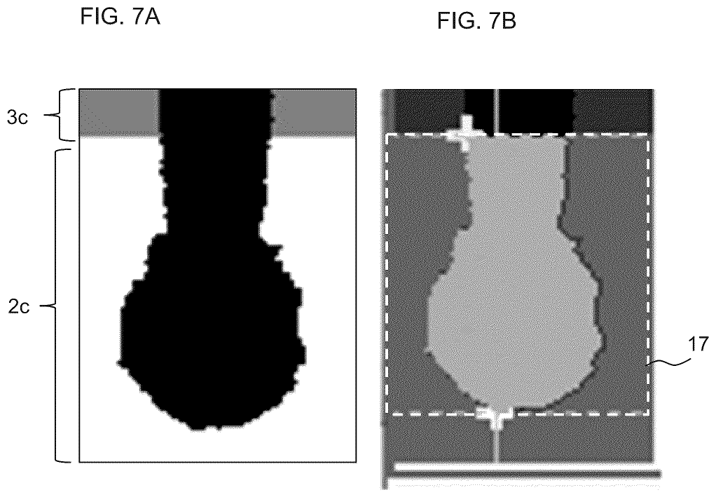

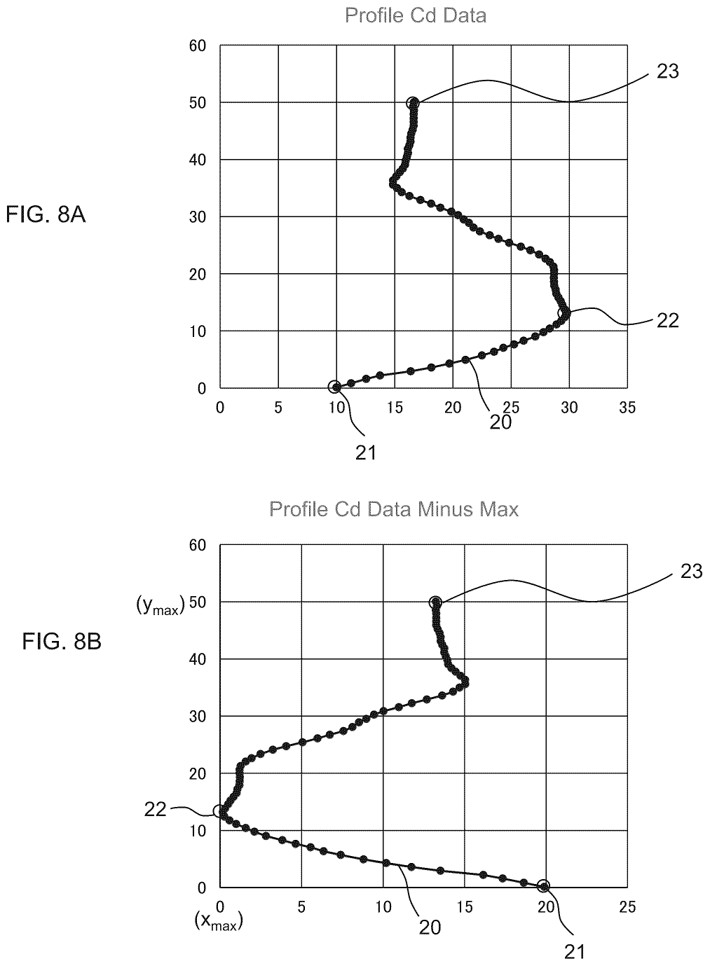

Referring to FIGS. 7A and 7B and FIGS. 8A and 8B, the following describes a specific example of the data in FIG. 6. FIGS. 7A and 7B illustrates an example of a profile diagram. FIGS. 8A and 8B illustrates an example of the data obtained through the process of data preparation.

FIGS. 7A and 7B is a profile diagram with the edge obtained from a SEM image using edge detection software. FIGS. 7A and 7B is obtained after step S2 in FIG. 6. In FIG. 7A, the outline of the processing layer 2c and photoresist layer 3c is extracted from the microscopic image including the processing layer 2c and the photoresist layer 3c. FIG. 7B illustrates a case where a target range 17 to be evaluated is extracted from the profile diagram.

FIG. 8A is obtained after step S3 in FIG. 6. In FIG. 8A, the outline 20 is shown, which is the edge (outline) between the trench and the semiconductor processing layer. The outline 20 is a collection of data, in which N (N is a positive integer) coordinates are defined, and is derived by smoothing the edge. In the profile diagram, the lowest point 21, which is the lowest point of the outline 20, is the bottom of the profile and indicates the lowest point. The profile diagram is transformed so that the lowest point 21 is located at y=0. A part on the left of the outline 20 in the drawing corresponds to the trench, and a part on the right of the outline 20 corresponds to the cross-section of the semiconductor processing layer. The top point 23, the uppermost point of the outline 20, is the edge of the semiconductor processing layer and corresponds to the edge between the semiconductor processing layer and the photoresist layer.

FIG. 8B is obtained after step S4 in FIG. 6. The lateralmost point 22 is the end of a line segment defining the maximum width wₘₐₓ of the trench in the outline 20. In FIG. 8B, the outline 20 is inverted so that the lateralmost point 22 is located at x=0. In the following description, the value of the y-coordinate of the top point 23 is also written as yₘₐₓ. The position of x=0 is also the point where the maximum width wₘₐₓ is achieved. Therefore, (xₘₐₓ) is also written at the position of x=0. That is an example of the transformation for inverting the outline 20, but the method of transformation is not limited to this. For instance, the present disclosure is applicable also to the case where the outline 20 is moved in parallel.

The prepared profile data is used for calculations in the area and distance methods.

### (Calculation by Area Method)

After preparing the profile data according to the above description and defining the unique extrema, the area number can be calculated. When calculating the area number, a block region showing an ideal rectangular shape is set as illustrated in FIGS. 4A and 4B. The process of setting a block region is the second step, following the process of data preparation (first step), to create a template of the target shape in the cross-sectional shape obtained from the dimension. The process of calculating a metric is the third step to compare a difference between the template and the cross-sectional shape using a normalized metric. Here, there are several possible ways to set the block region and calculate the metric. The following describes Methods 1 and 2 for calculating the area number according to the way of setting a block region.

### (Method 1)

The ideal shape is decided by unique extrema. In the area method, the dimensions are the maximum width of the cross-sectional shape and maximum depth of the cross-sectional shape, the template is the rectangular formed based on the maximum width and the maximum depth, and the metric is the area difference between the template (the template) and the cross-sectional shape.

In general, a box created to assume an ideal shape (template) is defined by the maximum width and height (depth) observed in the profile to be evaluated.

If the x-coordinate value xₘₐₓ of the widest part of the profile is not located at the y-coordinate value yₘₐₓ of the top of the profile, this method deals with any shoulder region located above xₘₐₓ in the same way as the shoulder region on the bottom side of the profile.

Thus, Method 1 can be used to describe and optimize the overall profile agreement to an ideal shape with the same unique extrema to determine the squareness of the profile, and is offered as the definition where its ideal value would be 1 since there would be no shoulder region to measure.

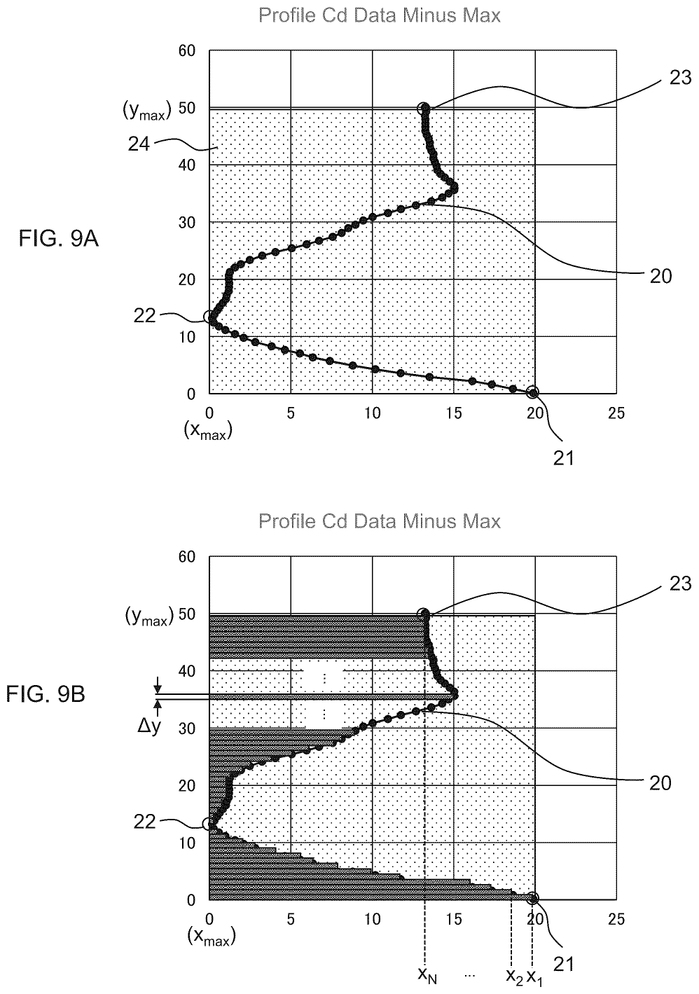

FIGS. 9A and 9B illustrate a case where the block region 24 indicating the ideal shape is set so as to include the shoulder region located above the point having the x-coordinate value xₘₐₓ. As illustrated in FIG. 9A, in Method 1 for the area method, the block region 24 indicating the ideal shape includes the lowest point 21, which is the bottom (y=0), the lateralmost point 22, which is the end when the maximum width wₘₐₓ is achieved and is the point at x=xₘₐₓ, and the top point 23, which indicates the maximum height of the trench (y=yₘₐₓ). A region surrounded by the outline 20, the coordinate axis of x=0, and the coordinate axis of y=0 corresponds to the shoulder region.

As illustrated in FIG. 9B, the area of the shoulder region is calculated by dividing the shoulder region into rectangles having long sides parallel to the y-axis direction and taking the sum of the areas of the rectangles, for instance. Each rectangle has a side with a length Δy in the y-axis direction, and has a side with a length up to a point set on the outline 20.

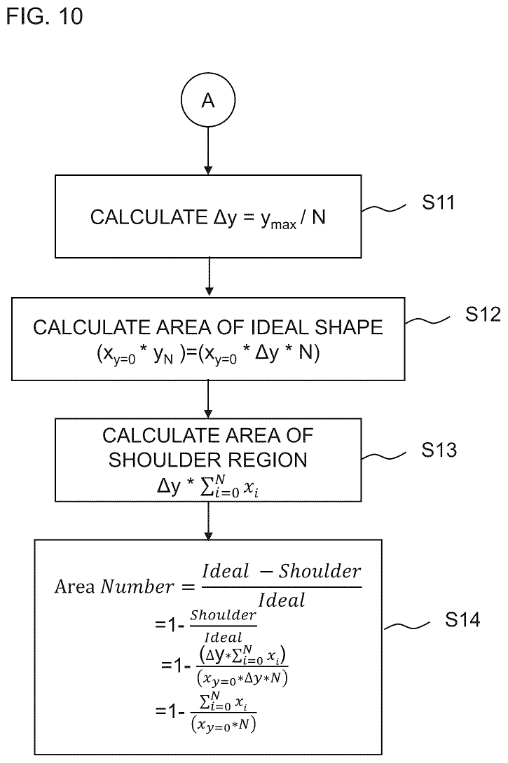

FIG. 10 illustrates the process of calculating the area number in Method 1. First, the length Δy of a side in the y-axis direction of the rectangle obtained by dividing the shoulder region is calculated by the following equation (3) (step S11). N is the number of coordinates on the outline 20 set by the edge detection software. Thus, Δy is determined based on the resolution of the edge detection software.

$$\begin{matrix}[ Mathematical 3 ] & \\ Δ y = {y}_{max} / N & ( 3 )\end{matrix}$$

Subsequently, the area of the ideal shape is calculated (step S12). The area S_{ideal} of the block region 24, which represents the ideal shape, is calculated as the following equation (4).

$$\begin{matrix}[ Mathematical 4 ] & \\ {S}_{Ideal} = {x}_{y = 0} \times {y}_{max} = {x}_{y = 0} \times Δ y \times N & ( 4 )\end{matrix}$$

Subsequently, the area of the shoulder region is calculated (step S13). The shoulder region S_{Shoulder} is approximated by the area of N pieces of rectangles and is calculated as the following equation (5). Here, xᵢ (i is an integer of 1 or more and N or less) indicates the x-coordinate value of the N coordinates set on the outline 20.

$$\begin{matrix}[ Mathematical 5 ] & \\ {S}_{Shoulder} = Δ y \times {\sum }_{i = 0}^{N} {x}_{i} & ( 5 )\end{matrix}$$

Finally, using equations (3) to (5), the area number is calculated as in the following equation (6) (step S14).

$$\begin{matrix}[ Mathematical 6 ] & \\ \begin{matrix}Area Number = \frac{{S}_{Ideal} - {S}_{Shoulder}}{{S}_{Ideal}} \\ = 1 - \frac{{S}_{Shoulder}}{{S}_{Ideal}} \\ = 1 - \frac{Δ y \times {\sum }_{i = 0}^{N} {x}_{i}}{{x}_{y = 0} \times Δ y \times N} \\ = 1 - \frac{{\sum }_{i = 0}^{N} {x}_{i}}{{x}_{y = 0} \times N}\end{matrix} & ( 6 )\end{matrix}$$

### (Method 2)

To monitor and control a profile, it is useful to use and define the height of the ideal shape as the y-coordinate value of the widest point of the profile, instead of the y-coordinate value yₘₐₓ.

This makes the area value very sensitive to any shape where yₓ₌ₓₘₐₓ<yₘₐₓ in the case of a profile disadvantage of x_{y=ymax}<xₘₐₓ. Such a condition occurs, for example, in a circumstance encountered in semiconductor process engineering referred to as a “side etch”.

If there are many wide profile points, such as in a perfect rectangular profile where the x-coordinate values are close to xₘₐₓ, defining the widest point at the top of the ideal shape will reduce sensitivity to the value of squareness. On the contrary, defining the narrowest point at the top of the ideal shape results in a very sensitive squareness value when describing just the bottom of the profile, but can lead to misleading of the squareness value.

When xₘₐₓ is at yₘₐₓ, in other words, when the point where the profile widest is the lateralmost point and the top point, the ideal shape is identical to the definition of Method 1.

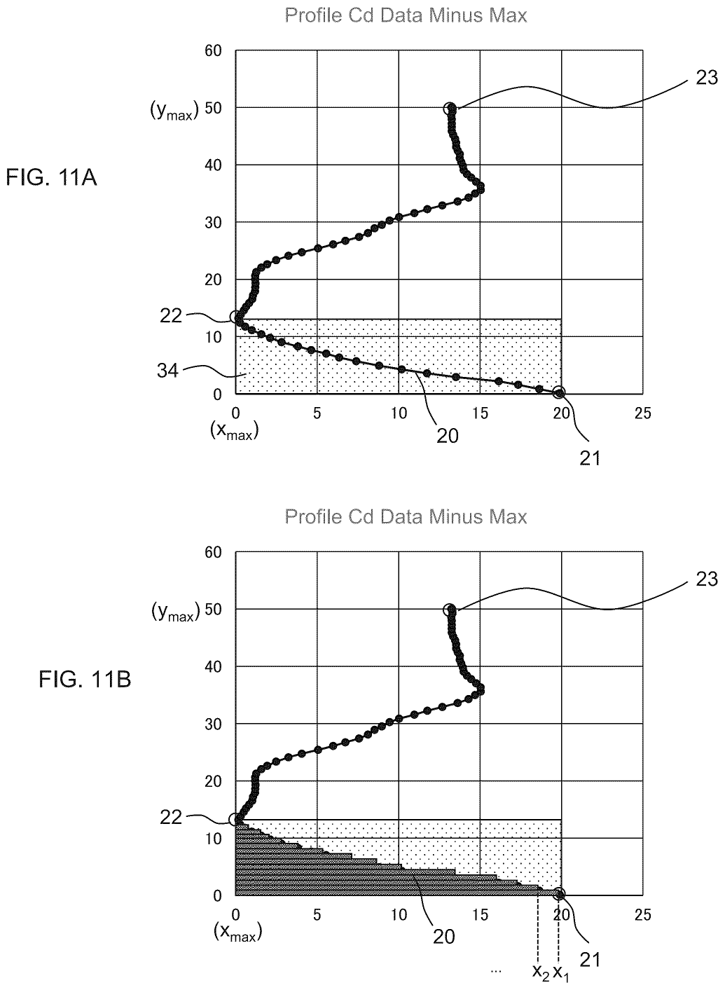

FIGS. 11A and 11B illustrate a case where the block region 34, which represents the ideal shape, is set in the range of points with the value xₘₐₓ of the x coordinate. As illustrated in FIG. 11A, in Method 2 for the area method, the block region 34 indicating the ideal shape includes the lowest point 21, which is the bottom (y=0), and the lateralmost point 22, which is the end when the maximum width wₘₐₓ is achieved and is the point at X=xₘₐₓ. The height up to the lateralmost point 22 (the y-coordinate of the lateralmost point 22) is equal to the height of the block region 34.

As illustrated in FIG. 11B, similarly to Method 1, the area of the shoulder region is calculated by dividing the shoulder region into rectangles having long sides parallel to the y-axis direction and taking the sum of the areas of the rectangles.

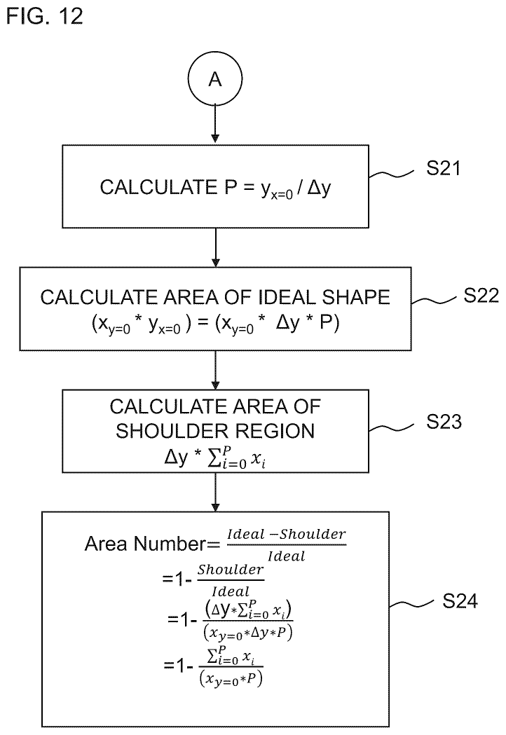

FIG. 12 illustrates the process of calculating the area number in Method 2. First, the number P (P is an integer equal to or less than N) of the rectangles obtained by dividing the shoulder region is calculated by the following equation (7) (step S21). Ay is derived from equation (3).

$$\begin{matrix}[ Mathematical 7 ] & \\ P = {y}_{x = 0} / Δ y & ( 7 )\end{matrix}$$

Subsequently, the area of the ideal shape is calculated (step S22). The area S_{ideal} of the block region 34, which represents the ideal shape, is calculated as the following equation (8).

$$\begin{matrix}[ Mathematical 8 ] & \\ {S}_{Ideal} = {x}_{y = 0} \times {y}_{y = 0} = {x}_{y = 0} \times Δ y \times P & ( 8 )\end{matrix}$$

Subsequently, the area of the shoulder region is calculated (step S23). The shoulder region S_{Shoulder} is approximated by the area of P pieces of rectangles and is calculated as the following equation (9).

$$\begin{matrix}[ Mathematical 9 ] & \\ {S}_{Shoulder} = Δ y \times {\sum }_{i = 0}^{P} {x}_{i} & ( 9 )\end{matrix}$$

Finally, using equations (7) to (9), the area number is calculated as in the following equation (10) (step S24).

$$\begin{matrix}[ Mathematical 10 ] & \\ \begin{matrix}Area Number = \frac{{S}_{Ideal} - {S}_{Shoulder}}{{S}_{Ideal}} \\ = 1 - \frac{{S}_{Shoulder}}{{S}_{Ideal}} \\ = 1 - \frac{Δ y \times {\sum }_{i = 0}^{P} {x}_{i}}{{x}_{y = 0} \times Δ y \times P} \\ = 1 - \frac{{\sum }_{i = 0}^{P} {x}_{i}}{{x}_{y = 0} \times P}\end{matrix} & ( 10 )\end{matrix}$$

### (Calculation by Distance Method)

The following describes the calculation by distance method. In the distance method, the dimensions and the template can be set in the similar manner as for the area method and the metric is the shortest among distances from a corner of the rectangle to the cross-sectional shape. After creating the profile data according to FIG. 6 and the related description and defining unique extrema, the distance value is calculated.

### (Scaling)

To arrive at a dimensionless metric and to ensure that different shapes can be sensibly compared, the profile data is scaled by the previously calculated unique extrema. The scaling method can be selected from the methods described below.

To preserve the aspect ratio, both x and y are scaled by the same constant α.

If it is desirable to ensure that the distance method metric is always less than 1, it is necessary to ensure that a is equal to or greater than xₘₐₓ and yₘₐₓ in all considered samples. This is often difficult in practice because xₘₐₓ and yₘₐₓ are relative in size and the extrema of both can vary widely from sample to sample.

Thus, if a single parameter is used to scale both the x-coordinate data and the y-coordinate data, it cannot be guaranteed that the distance value will always be less than 1 nor that it can be meaningfully compared to other profiles outside the collection of data. But the method can still be useful for the analysis.

It is also possible to scale x and y by α and β, respectively, by introducing another scaling parameter β=yₘₐₓ and choosing α=xₘₐₓ, so that the value of the distance method is always less than 0. This enables universally meaningful comparisons at the expense of some abstraction from the original shape of the profile due to aspect ratio distortions.

Similar to the area method, β=yₘₐₓ can also be replaced with β=yₓ₌ₓₘₐₓ. This is equally detrimental to any “side-etched” sample, but can derive irregular values observed in the distance method.

After calculating the region of interest and choosing a scaling method, the distances of all data points in the data collection can be measured to find the point that has the minimum length and is therefore the closest.

This is the definition of a distance method value where the ideal value for a perfectly rectangular shaped profile is 0.

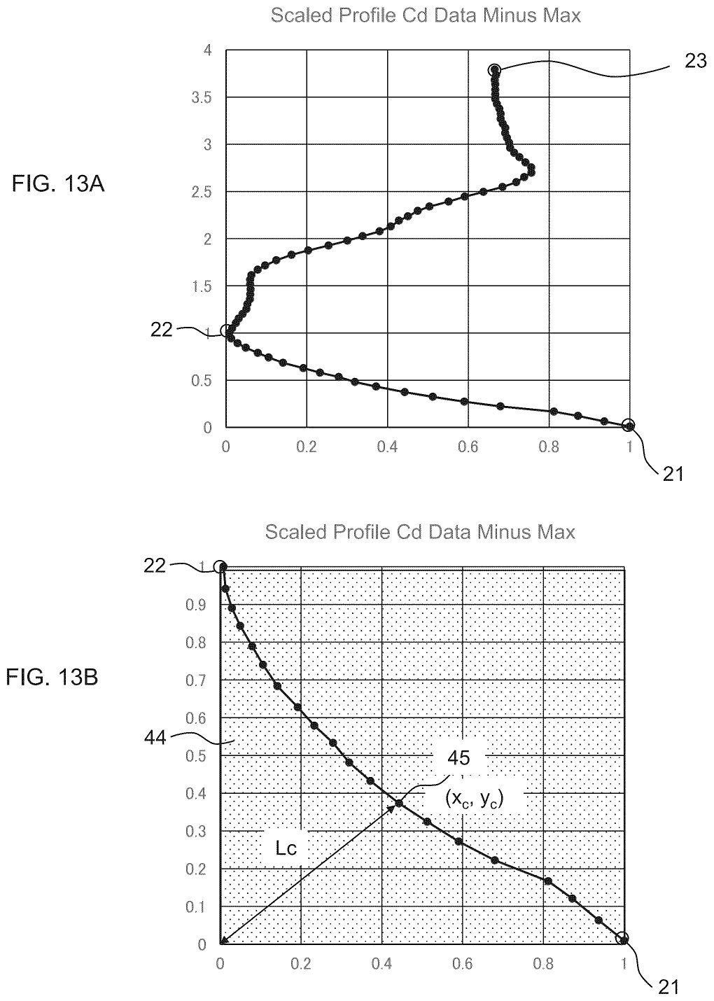

FIGS. 13A and 13B illustrate an example of scaling a profile diagram. FIG. 13A illustrates a scaled case, and FIG. 13B illustrates an enlarged part of FIG. 13A. The y-coordinate data is divided by the y-coordinate value of yₓ₌ₓₘₐₓ (the lateralmost point 22), and the x-coordinate data is divided by the x-coordinate value of the lowest point 21. The scaling method is not limited to that illustrated in FIGS. 13A and 13B, and can be appropriately set according to the type of etching shape and evaluation method.

An ideal shape 44 is set as illustrated in FIG. 13B. The ideal shape 44 is a rectangle having corners of (0, 0), (0, 1), which is the lateralmost point 22, (1, 0), which is the lowest point 21, and (1, 1). Then, the distance Lc between (0, 0) of the ideal shape 44 and the closest point 45 (x_{c}, y_{c}), which is the closest point to (0, 0), is calculated as the distance number.

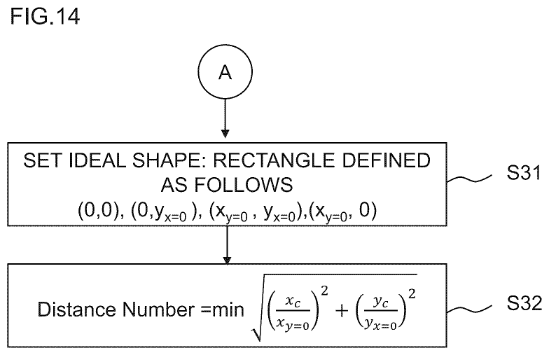

FIG. 14 illustrates the process of calculating the distance number in the distance method. First, an ideal shape is set in the profile diagram (step S31). The ideal shape is a rectangle with corners at (0, 0), (0, yₓ₌₀). (x_{y=0}, yₓ₌₀), (x_{y=0}, 0). Here, yₓ₌₀ indicates the value of the y-coordinate of the point corresponding to the edge of the trench when the trench has the maximum width. Also, x_{y=0} indicates the x-coordinate value of the point corresponding to the bottom of the trench.

Subsequently, the point closest to (0, 0) in the profile diagram is extracted and the distance number is calculated (step S32). The distance number is derived by the following equation (11).

$$\begin{matrix}[ Mathematical 11 ] & \\ Distance number = min \sqrt{{( \frac{{x}_{c}}{{x}_{y = 0}} )}^{2} + {( \frac{{y}_{c}}{{y}_{x = 0}} )}^{2}} & ( 11 )\end{matrix}$$

The distance between the corner (0, 0) of the ideal shape 44 and the closest point is calculated in this example, but depending on how the ideal shape is set, the corner of the ideal shape may not overlap the coordinates (0, 0). In that case, the distance between an appropriate corner of the ideal shape and the closest contact point is calculated as the distance number.

### (System Configuration)

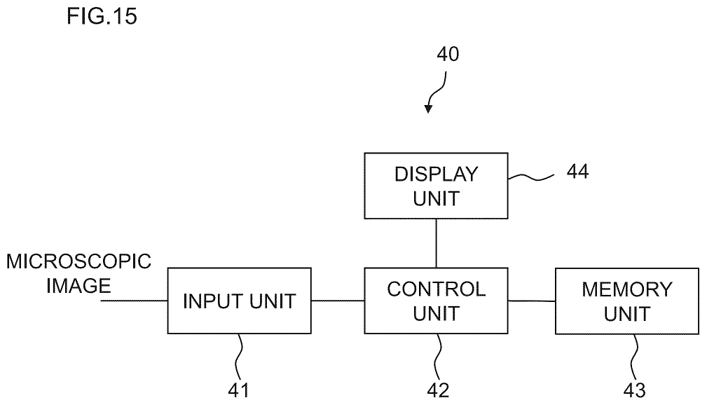

FIG. 15 illustrates an example of the configuration of an evaluation system, with which the evaluation method described in this disclosure is performed. The evaluation system 40 includes an input unit 41, a control unit 42, a memory unit 43, and a display unit 44. The evaluation system 40 is a search system that uses machine learning to search for an etching condition that brings a processing result by a plasma etching apparatus to a target shape. In addition, in the evaluation system 40, it is performed that A search method using machine learning to search for an etching condition that brings a processing result by a plasma etching apparatus to a target shape.

The input unit 41 serves as an interface, through which inter-device data and other data, as well as requests from users of the evaluation system 40, are input to the evaluation system 40. The input unit 41 acquires a microscopic image generated by a microscope apparatus such as a SEM. The input unit 41 can also acquire data on the processing conditions of a semiconductor processing substrate, the data being linked to the microscopic image.

The control unit 42 performs processing for image evaluation. For instance, the control unit 42 runs the edge detection software, prepares an image as illustrated in FIG. 6, and generates a profile diagram from the microscopic image. The control unit 42 also executes the process of the area method illustrated in FIG. 10 and FIG. 12, and the distance method illustrated in FIG. 14.

The memory unit 43 stores the edge detection software. The storage unit 43 also stores a program for performing the area method and a program for performing the distance method. The storage unit 43 stores the area number and distance number calculated by the control unit 42 in association with the processing conditions of the semiconductor processing substrate.

The display unit 44 presents the image evaluation results including the area number and distance number calculated by the control unit 42 to the user.

The control unit 42 can also perform machine learning using the image evaluation results as one of the objective variables and perform processing condition optimization to search for optimized processing conditions.

### (Evaluation Example)

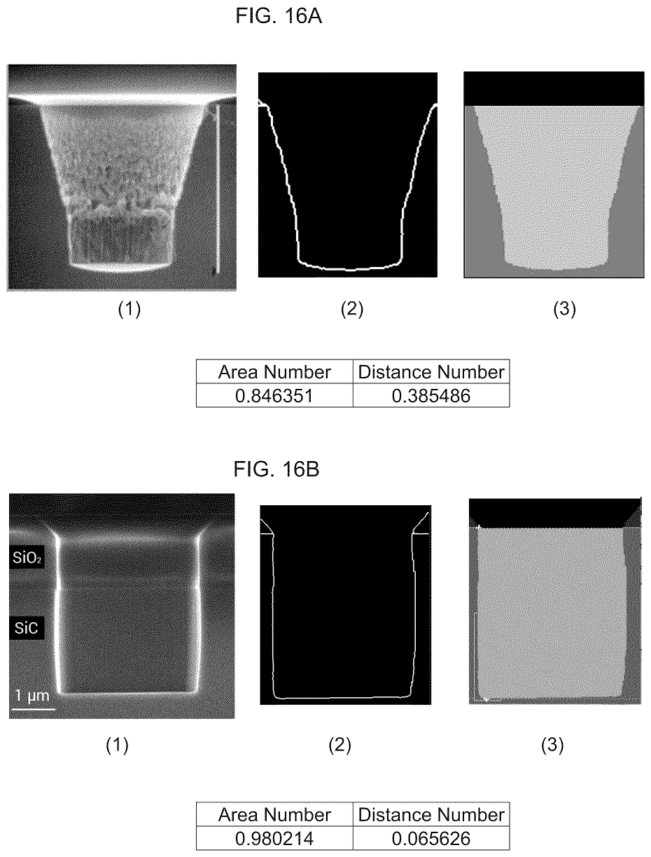

Referring to FIGS. 16A and 16B, the following describes an example of applying the area method and the distance method to evaluation of a semiconductor structure. FIGS. 16A and 16B illustrate the results of evaluating a semiconductor structure. Two types of semiconductor structures are evaluated, as illustrated in FIGS. 16A and 16B. In FIGS. 16A and 16B, drawing (1) represents the SEM image. Drawing (2) is the profile diagram obtained by performing edge detection processing. Drawing (3) represents the profile highlighted in a different color.

In the structure of FIG. 16A, the area number is 0.846351 and the distance number is 0.385486. In the structure of FIG. 16B, the area number is 0.980214 and the distance number is 0.065626. Note that the ideal shape of the trench after the etching process is a rectangle, and the area number of the structure in FIG. 16B is larger than the area number of the structure in FIG. 16A. It can be inferred that the shape of the trench in FIG. 16B has a space closer to a rectangle.

Note that the distance number indicates a difference from the ideal shape, especially for the shape of the bottom of the trench, and the distance number for the structure in FIG. 16B is smaller than the distance number for the structure in FIG. 16A. It can be inferred that the shape of the trench in FIG. 16B keeps flatness, especially at the bottom.

Possible non-limiting aspects of the present invention are set forth below:

### (Aspect 1)

An evaluation method that evaluates a difference between a target shape and a cross-sectional shape of an electron microscopic image, comprising:
a first step of measuring a characteristic dimension of the cross-sectional shape;
after the first step, a second step of creating a template of the target shape in the cross-sectional shape obtained from the dimension; and
a third step of comparing a difference between the template and the cross-sectional shape using a normalized metric.

### (Aspect 2)

In the evaluation method according to aspect 1,
the dimension includes a maximum width of the cross-sectional shape and a maximum depth of the cross-sectional shape, and
the template is a rectangle formed based on the maximum width and the maximum depth.

### (Aspect 3)

In the evaluation method according to aspect 1 or 2,
a difference in area between the rectangle and the cross-sectional shape is used as the metric.

### (Aspect 4)

In the evaluation method according to any one of aspects 1 to 3,
a shortest distance among distances from a corner of the rectangle to the cross-sectional shape is used as the metric.

### (Aspect 5)

A search method using machine learning to search for an etching condition that brings a processing result by a plasma etching apparatus to a target shape, comprising:
a first step of measuring a characteristic dimension of a cross-sectional shape;
after the first step, a second step of creating a template of the target shape in the cross-sectional shape obtained from the dimension; and
a third step of comparing a difference between the template and the cross-sectional shape using a normalized metric, the method using, as one of objective variables, an evaluation result of an electron microscopic image obtained by execution of the third step.

### (Aspect 6)

A search system using machine learning to search for an etching condition that brings a processing result by a plasma etching apparatus to a target shape, the system performing:
a first step of measuring a characteristic dimension of a cross-sectional shape;
after the first step, a second step of creating a template of the target shape in the cross-sectional shape obtained from the dimension; and
a third step of comparing a difference between the template and the cross-sectional shape using a normalized metric, the system using, as one of objective variables, an evaluation result of a microscopic image obtained by execution of the third step.

### DESCRIPTION OF REFERENCE NUMERALS

1, 1a, 1b: semiconductor substrate, 2, 2a, 2b, 2c: processing layer, 3, 3a, 3c: photoresist layer, 4, 4a, 4b: trench, 10: bottom, 11: box region, 12: shoulder region, 17: target range, 20: outline, 21: lowest point, 22: lateralmost point, 23: top point, 24, 34: block region, 40: evaluation system, 41: input unit, 42: control unit, 43: memory unit, 44: display unit, 44: ideal shape, 45: closest point

1. An evaluation method that evaluates a difference between a target shape and a cross-sectional shape of an electron microscopic image, comprising:
a first step of measuring a characteristic dimension of the cross-sectional shape;
after the first step, a second step of creating a template of the target shape in the cross-sectional shape obtained from the dimension; and
a third step of comparing a difference between the template and the cross-sectional shape using a normalized metric.

2. The evaluation method according to claim 1, wherein
the dimension includes a maximum width of the cross-sectional shape and a maximum depth of the cross-sectional shape, and
the template is a rectangle formed based on the maximum width and the maximum depth.

3. The evaluation method according to claim 2, wherein
a difference in area between the rectangle and the cross-sectional shape is used as the metric.

4. The evaluation method according to claim 2, wherein
a shortest distance among distances from a corner of the rectangle to the cross-sectional shape is used as the metric.

5. A search method using machine learning to search for an etching condition that brings a processing result by a plasma etching apparatus to a target shape, comprising:
a first step of measuring a characteristic dimension of a cross-sectional shape;
after the first step, a second step of creating a template of the target shape in the cross-sectional shape obtained from the dimension; and
a third step of comparing a difference between the template and the cross-sectional shape using a normalized metric, the method using, as one of objective variables, an evaluation result of an electron microscopic image obtained by execution of the third step.

6. A search system using machine learning to search for an etching condition that brings a processing result by a plasma etching apparatus to a target shape, the system performing:
a first step of measuring a characteristic dimension of a cross-sectional shape;
after the first step, a second step of creating a template of the target shape in the cross-sectional shape obtained from the dimension; and
a third step of comparing a difference between the template and the cross-sectional shape using a normalized metric, the system using, as one of objective variables, an evaluation result of a microscopic image obtained by execution of the third step.
